(19) United States
(12) Patent Application Publication
(10) Pub. No.: US 2014/0082830 A1
(43) Pub. Date: Mar. 27, 2014

(54) GARMENT WITH INTEGRATED FALL ARREST SAFETY HARNESS

(71) Applicant: Global Outdoor Resources, Cannon Falls, MN (US)

(72) Inventors: Andrea Ruhl, Genoa, IL (US); Scott Shultz, Cannon Falls, MN (US)

(21) Appl. No.: 14/034,269

(22) Filed: Sep. 23, 2013

Related U.S. Application Data
(60) Provisional application No. 61/704,282, filed on Sep. 21, 2012.

(51) Int. Cl. A62B 35/00

(52) U.S. Cl. CPC A62B 35/0006
USPC 2/455

(57) ABSTRACT

In some examples, a kit comprising a garment to be worn by a user; a fall arrest safety harness integrated into the garment; and a suspension relief strap configured to be coupled to the fall arrest safety harness, and wherein the fall arrest safety harness is integrated into the garment such that, when the garment is worn by the user, the fall arrest safety harness is worn by the user in a manner that arrests a fall by the user when the fall arrest safety harness is anchored.

This application claims the benefit of U.S. Provisional Application No. 61/704,282 filed Sep. 21, 2012, the entire content of which is incorporated herein by reference.

### TECHNICAL FIELD

The invention relates to garments, particularly garments including an integrated fall arrest safety harness.

### SUMMARY

Aspects related to a garment assembly having an integrated fall arrest safety harness are described. The garment assembly may include a garment, such as overalls or other clothing (including odor control clothing or garments), and the fall arrest safety harness integrated into the garment. The harness may provide a way by which to connect to a tether that can be anchored. The safety harness may be integrated into the garment such that, when worn by a user and properly anchored, the garment assembly may arrest a fall by the user, e.g., from a tree, building or other structure. In this manner, the garment assembly may provide a single product where the safety harness has been specifically designed to work with the garment. After arresting a fall, a user may couple a suspension relief strap to the fall arrest safety harness, e.g., to reduce the risk of suspension trauma and help alleviate harness pressure while the user is suspended.

In some examples, a kit may be assembled, where the kit includes a garment assembly having an integrated fall arrest safety harness and a suspension relief strap configured for use with the safety harness all within the same package. In this manner, customers may more easily identify and purchase a garment, safety harness, and suspension relief strap that are configured to be used in combination with each other in that the customer does not have to purchase separately a garment, a fall arrest safety harness designed for use with that garment, and a suspension relief strap designed for use with that garment. Instead, the customer may purchase a single package including all components. Moreover, such a kit may allow for manufacturing and sales efficiencies.

In one embodiment, a kit comprising a garment to be worn by a user; a fall arrest safety harness integrated into the garment; and a suspension relief strap configured to be coupled to the fall arrest safety harness, and wherein the fall arrest safety harness is integrated into the garment such that, when the garment is worn by the user, the fall arrest safety harness is worn by the user in a manner that arrests a fall by the user when the fall arrest safety harness is anchored.

In another embodiment, a method comprising assembling a kit, the kit comprising a garment to be worn by a user; a fall arrest safety harness integrated into the garment; and a suspension relief strap configured to be coupled to the fall arrest safety harness, and wherein the fall arrest safety harness is integrated into the garment such that, when the garment is worn by the user, the fall arrest safety harness is worn by the user in a manner that arrests a fall by the user when the fall arrest safety harness is anchored.

The details of one or more embodiments of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is conceptual diagram illustrating an example kit including a garment assembly having an integrated fall arrest safety harness and a suspension relief strap.

FIG. 2 is photographs of example disassembled components of a kit according to one example of the disclosure.

FIGS. 3A-3D are diagrams illustrating an example garment assembly that incorporates the techniques of this disclosure from various perspectives.

FIG. 4 is a diagram showing a removable tether that may be used in conjunction with the garment assembly shown in the example of FIGS. 3A-3D.

FIG. 5 is a series of photos illustrating a suspension relief strap that may be used in conjunction with the garment assembly shown in the example of FIGS. 3A-3D.

FIG. 6 is a series of photos illustrating a tree strap that may be used in conjunction with the garment assembly shown in the example of FIGS. 3A-3D.

FIG. 7 is a series of photos of the harness shown in the examples of FIGS. 3A-3D that is able to be integrated into the garment shown in the example of FIGS. 3A-3D.

### DETAILED DESCRIPTION

As described above, aspects related to a garment assembly having an integrated fall arrest safety harness are described. The garment assembly may include a garment, such as overalls or other clothing (including odor control clothing or garments used, e.g., for hunting), and the fall arrest safety harness integrated into the garment. The harness may provide a way by which to connect to a tether that can be anchored. The safety harness may be integrated into the garment such that, when worn by a user and properly anchored, the garment assembly may arrest a fall by the user, e.g., from a tree, building or other structure. In this manner, the garment assembly may provide a single product where the safety harness has been specifically designed to work with the garment. After arresting a fall, a user may couple a suspension relief strap to the fall arrest safety harness, e.g., to reduce the risk of suspension trauma and help alleviate harness pressure while the user is suspended.

In some examples, a kit may be assembled, where the kit includes a garment assembly having an integrated fall arrest safety harness and a suspension relief strap configured for use with the safety harness all within the same package. In this manner, customers may more easily identify and purchase a garment, safety harness, and suspension relief strap that are configured to be used in combination with each other in that the customer does not have to purchase separately a garment, a fall arrest safety harness designed for use with that garment, and a suspension relief strap designed for use with that garment. Instead, the customer may purchase a single package including all components. Moreover, such a kit may allow for manufacturing and sales efficiencies.

As will be described further below, such a kit may optionally include one or more other items related to the use of the garment with integrated fall arrest safety harness and suspension relief strap. For example, an instructions manual with instructions for using the contents of the kit, and a removable tether, anchor strap and/or a tree strap for coupling to the fall arrest harness (which may or may not be removable from the safety harness) may be contained within the same package as the garment with integrated fall arrest safety harness and suspension relief strap.

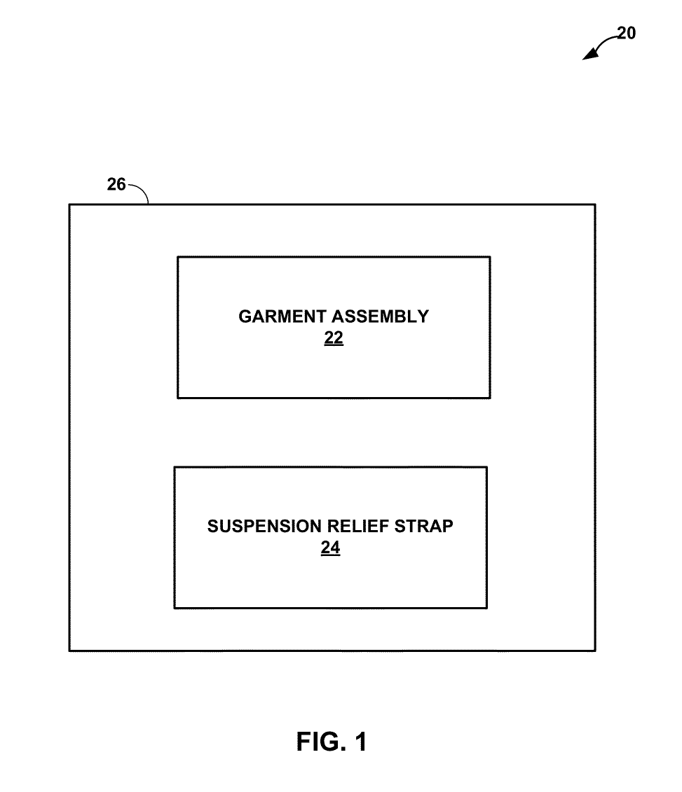

FIG. 1 is conceptual diagram illustrating an example kit 20 including a garment assembly 22 having an integrated fall arrest safety harness and a suspension relief strap 24 within packaging 26. As noted above, garment assembly 22 may include a garment, such as overalls or other clothing (including odor control clothing or garments used, e.g., for hunting), and a fall arrest safety harness integrated into the garment.

The garment of garment assembly 22 may take the form of any garment worn by a user during an activity in which it may be desirable to take precaution against a fall by the user. For example, garment assembly 22 may to take the form of a garment worn by industrial and construction workers that typically work at heights at which a fall would be dangerous. Similarly, garment assembly 22 may to take the form of a garment work by a user while hunting, e.g., from a tree stand or other elevated position. Example garments may take the form of coveralls, overalls, vest, jacket, shirt, parka, and the like. Example of garment assembly 22 may include one or more of the examples described in U.S. Pat. Nos. 6,698,026; 6,305,024; 6,892,395; and 6,658,666 to Schweer. The entire content of each of these patents is incorporated herein by reference. Other example garment assemblies are contemplated.

In each case, garment assembly 22 includes a fall arrest safety harness integrated in the garment. The fall arrest safety harness integrated into the garment of garment assembly 22 may provide a way by which to anchor assembly 22, e.g., via a tether. The safety harness may be integrated into the garment such that, when worn by a user and properly anchored, the garment assembly may arrest a fall by the user, e.g., from a tree, building or other elevated position.

Suspension relief strap 24 of kit 20 may be designed to be coupled to the fall arrest safety harness following the arrest of a fall be the user but while the user is still suspended. Suspension relief strap 24 may allow a user to relieve pressure caused by the harness while suspended, for example, by allowing a user to stand up in the fall arrest harness to relieve pressure caused by the thigh straps of the fall arrest safety harness and enter a seated posture. In this manner, suspension relief strap 24 may be used, e.g., to reduce the risk of suspension trauma and help alleviate harness pressure while the user is suspended. The fall arrest safety harness of garment assembly 22 may include a coupling ring or other structure that allows for the selective connection of suspension relief harness 24 to garment assembly 22 in a configuration that allows for relief of pressure from the harness with a user is suspended.

As noted above, suspension relief strap 24 and garment assembly 22 may be contained within packaging 26. Packaging may take the form of any suitable structure for containing suspension relief strap 24 and garment assembly 22 together within kit 20. In some examples, packaging 26 may take the form of a cardboard box, plastic bag, or plastic container. Packaging 26 may include one or more markings, such as, e.g., a UPC and description of the contents of packaging 26, used for the commercial sale of kit 20. As noted above, kit 20 is not limited to including only garment assembly 22 and suspension relief strap 24 but may include one or more other components, such as, e.g., an instructions manual with instructions for using the contents of kit 20, and a removable tether, an anchor strap and/or a tree strap for coupling to the fall arrest harness of garment assembly 22.

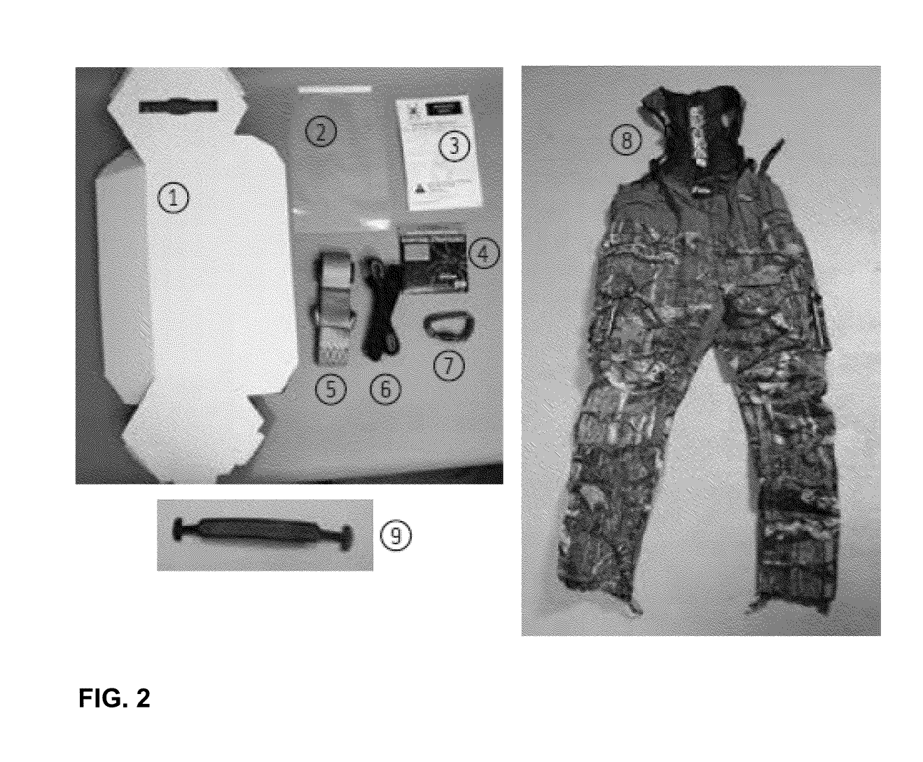

FIG. 2 is photographs of example disassembled components of a kit, such as, kit 20 of FIG. 1. As shown, kit 20 may include cardboard packaging box 1, plastic bag 2, instruction manual 3, DVD 4, tree strap 5, suspension relief strap 6, carabineer 7, garment assembly 8, and handle 9. When assembled, plastic bag 2, instruction manual 3, DVD 4, tree strap 5, suspension relief strap 6, carabineer 7, garment assembly 8, and black handle 9 may all be contained within cardboard packaging box 1. Handle 9 may be attached to the outside of cardboard packaging box 1 to allow for a user to more easily carry cardboard packaging box 1 and its contents.

Instruction manual 3 may contain written instructions and diagrams for using the contents of kit 20. In a similar fashion, DVD 4 for contain media instructing a user on using the contents of kit 20 as well as other marketing material. Tree strap 5 may be configured to be anchored, e.g., to a tree or other structure and also connected to fall arrest safety harness of garment assembly 8 to allow the garment assembly 8 to arrest the fall of a user when anchored via tree strap 5 (or other suitable tether). Carabineer 7 may be supplied in kit 20 as a component that allows for one or more items to be coupled, e.g., to garment assembly 8.

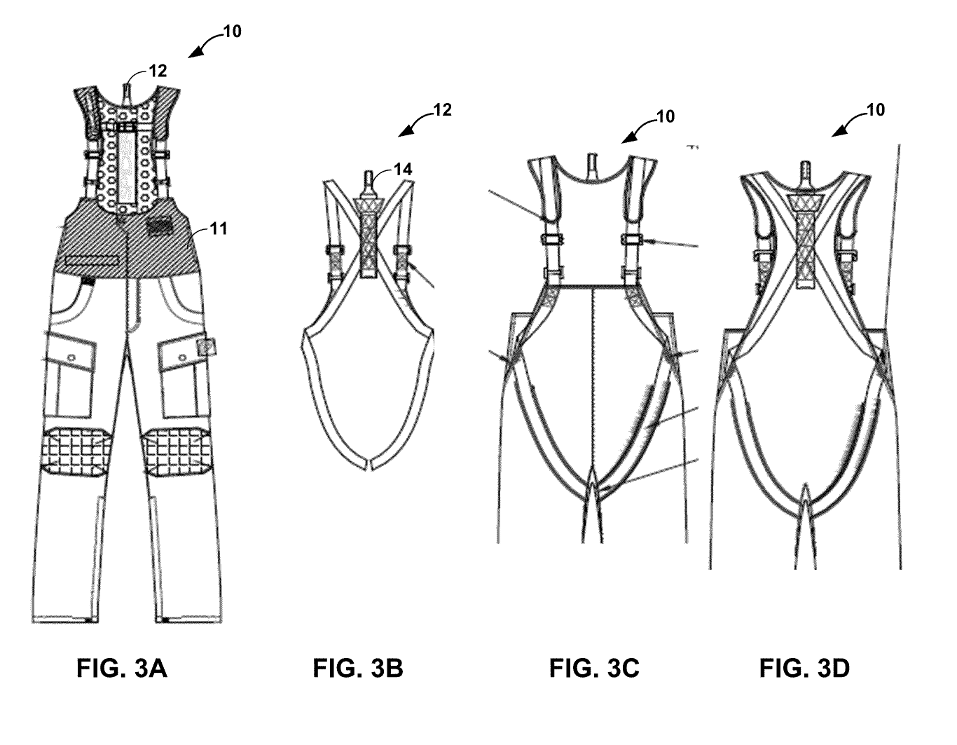

FIGS. 3A-3D are diagrams illustrating an example garment assembly 10 of this disclosure, such as, e.g., garment assembly 22. FIG. 3A is a diagram showing garment assembly 10 from a forward perspective. Garment assembly 10 includes a garment 11 and a safety harness 12. In some examples, harness 12 may be “integrated” into garment 11 in the sense that harness 12 may be attached (in either a removable or not removable fashion) to garment 11 such that, when garment 11 is worn by a user, harness 12 may properly function as a fall arrest safety harness for the user. For example, when garment assembly 10 is worn by a user and properly anchored, the fall of a user may be arrested before the user contacts the ground. As shown in the example of FIG. 3A, harness 12 may be integrated nearly seamlessly into garment assembly 10 such that harness 12 is not overtly noticeable or even fully visible. In this sense, garment 11 may appear as a garment (i.e., in the example of FIG. 3A, a normal pair of overalls).

Again, while shown as a pair of overalls in FIG. 3A-3D, garment 11 may comprise any other form of garment, including odor-control garments (where odor-control garments may comprise odor-control fabrics and/or garments that were manufactured to include odor-control properties). Examples include coveralls, pants, vests, jackets, and the like. In some examples, the garment may be designed to wear around the upper leg or thigh area, e.g., as is the case with pants, coveralls, overalls, and shorts, such that an integrated fall arrest safety harness is situated properly around the upper thighs of a user when the user wears the garment. As a comparison, a vest would not include such a portion but instead would be configured to be worn around the chest/upper torso portion of a user. The garments may be worn by users during various activities that safety harnesses are used, e.g., to arrest a potential fall by the user. Such activities may include hunting, e.g., from a tree stand, or industrial activities such as window washing or construction.

FIG. 3B is a diagram illustrating safety harness 12 of garment assembly 10 from a back perspective. Harness 12 may include a coupling 14 by which to couple to any one or more of a removable tether, a suspension relief strap and an anchor/tree strap. In some instances, harness 12 may include a sewn-in tether in addition to coupling 14. In other instances, harness 12 may replace coupling 14 with a sewn in tether. Safety harness 12 may include main load carrying straps that are made from primarily two pieces of webbing of the same or approximately the same lengths. As a result of these same lengths, the techniques may allow for easier manufacturing, while also allowing for uniform distribution, side to side, of a load.

FIG. 3C is a diagram illustrating garment assembly 10 from a front perspective. In the example of FIG. 1C, garment assembly 10 is shown with respect to garment 11 with detailing illustrating locations at which harness 12 is affixed to garment 11 (denoted by the red portions and various arrows).

FIG. 3D is a diagram illustrating garment assembly 10 from a back perspective, where again various red portions denote locations at which harness 12 is affixed to garment 11. By offering in a single integrated product composed of a garment, safety harness, and one or more of the following; removable tether, sewn in tether, suspension relief strap, anchor/tree strap, the techniques may allow for a single product to be designed to work together, for easier purchase for the customer and for manufacturing efficiencies.

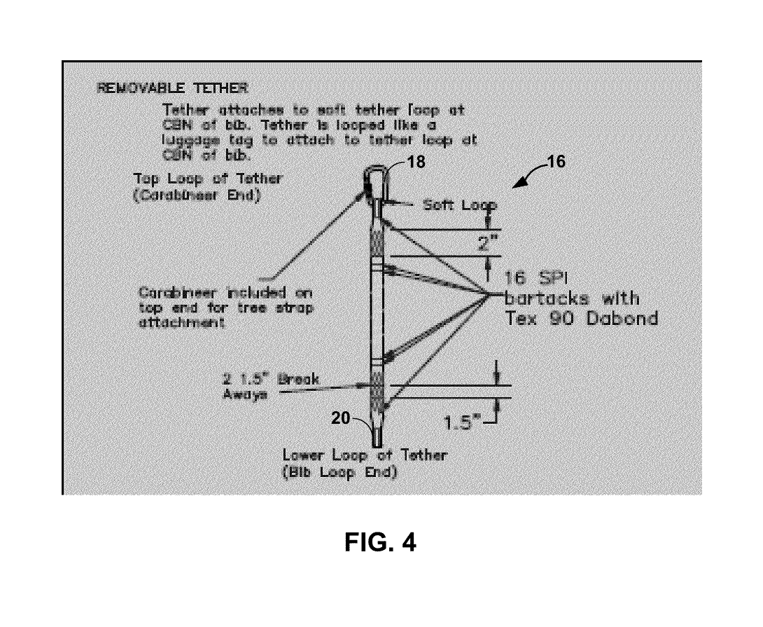

In some instances, the tether is removable. FIG. 4 is a diagram showing a removable tether 16. Tether 16 may, as noted in the example of FIG. 4, include a carabineer 18, which may be used to attach to additional equipment, such as a tree strap, anchor strap or suspension relief strap. Tether 16 may also include a coupling 20 (shown as “lower loop” in the example of FIG. 4) by which to couple with coupling 14 of harness 12. By allowing for removable tether 15, the techniques may allow for garment 11 to be worn for safety and/or as regular garment (given the seamless nature of integration noted above). In some instances, tether 16 may fit through a slit/opening in back of jacket. This slit may or may not be covered to protect from wind, rain, cold.

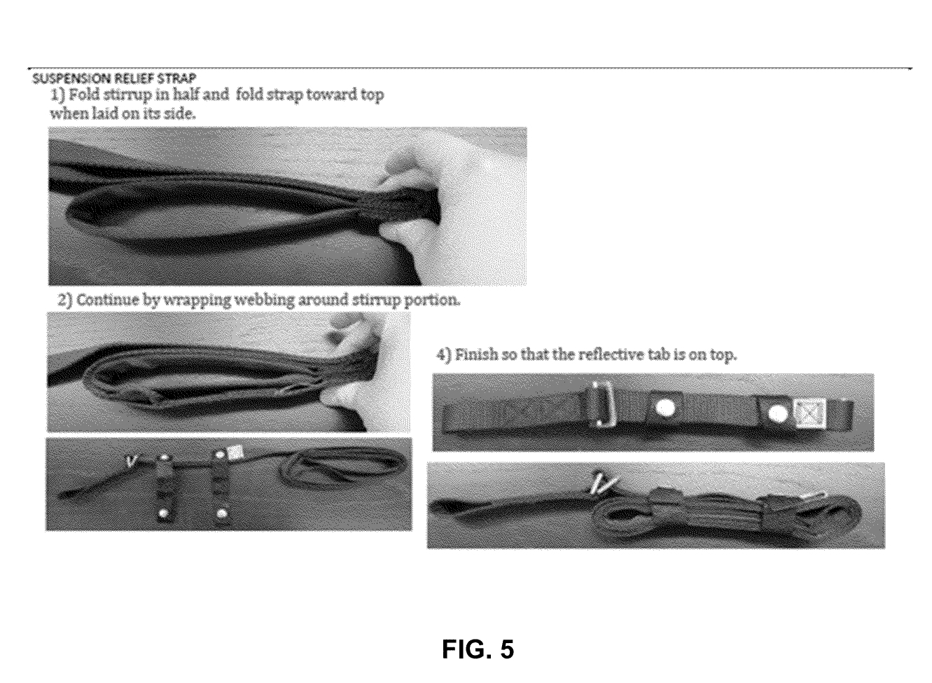

FIG. 5 is a series of photos illustrating a suspension relief strap that may be used in conjunction with, e.g., garment assembly 22 of FIG. 1 or garment assembly 10 of FIGS. 3A-3D.

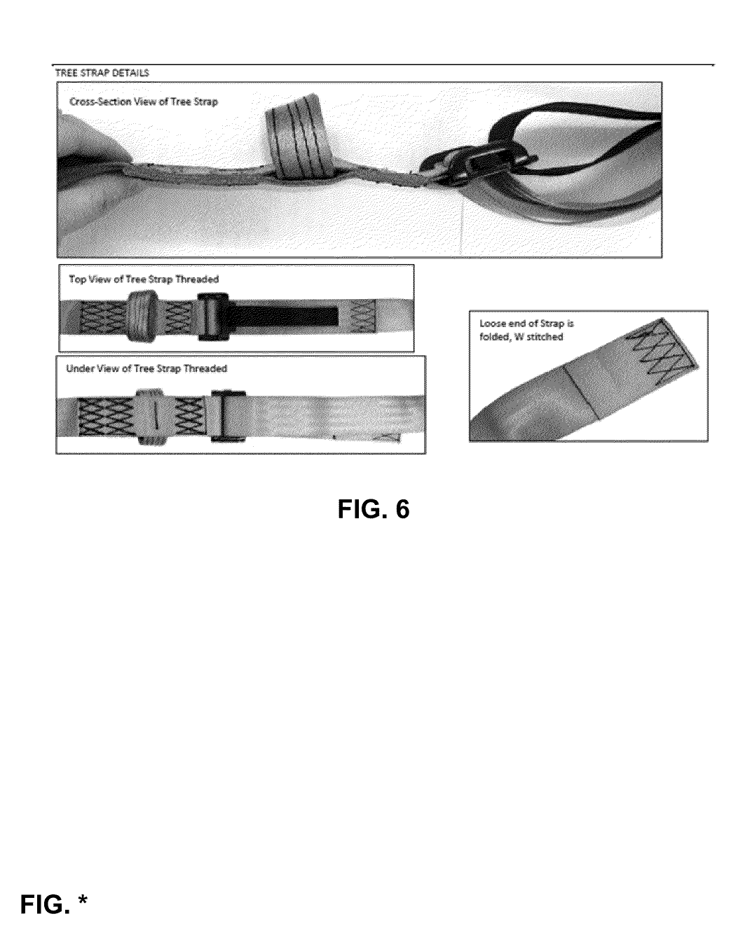

FIG. 6 is a series of photos illustrating a tree strap that may be used in conjunction with, e.g., garment assembly 22 of FIG. 1 or garment assembly 10 of FIGS. 3A-3D.

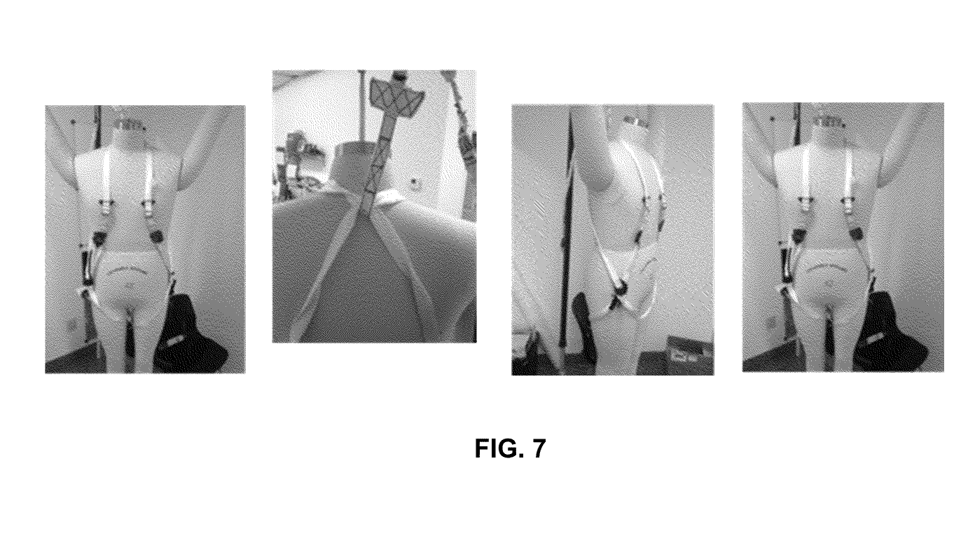

FIG. 7 is a series of photos of harness 12 of FIGS. 3A-3D which may be used, e.g., as a fall arrest harness of garment assembly 22 of FIG. 1 or garment assembly 10 of FIGS. 3A-3D.

The techniques described above may provide for a garment assembly that can be used in a wide variety of settings, such as hunting, construction, industrial safety, and other settings (including in companies that have self-controlled safety programs).

Various embodiments of the invention have been described. These and other embodiments are within the scope of the following claims.

1. A kit comprising:
a garment to be worn by a user;
a fall arrest safety harness integrated into the garment; and
a suspension relief strap configured to be coupled to the fall arrest safety harness, and wherein the fall arrest safety harness is integrated into the garment such that, when the garment is worn by the user, the fall arrest safety harness is worn by the user in a manner that arrests a fall by the user when the fall arrest safety harness is anchored.

2. The kit assembly of claim 1, wherein the safety harness is removable from the garment.

3. The kit assembly of claim 1, wherein the safety harness includes a coupling by which to couple to at least one of a removable tether, an anchor strap and a tree strap.

4. The kit assembly of claim 1, further comprising the at least one of the removable tether, the anchor strap and the tree strap.

5. The kit assembly of claim 1, wherein the safety harness is not overtly visible when viewing the garment.

6. The kit assembly of claim 1, wherein the garment comprises overalls.

7. The kit assembly of claim 1, wherein the garment includes a portion that, when worn by the user, substantially surrounds an upper thigh area of the user.

8. The kit assembly of claim 1, wherein the garment comprises an odor-control garment.

9. The kit assembly of claim 1, further comprising a tether configured to anchor the fall arrest safety harness.

10. The kit assembly of claim 9, wherein the tether is coupled to the fall arrest safety harness via stitching.

11. The kit assembly of claim 9, further comprising an instruction manual with instructions for using the garment, the fall arrest safety harness, and the suspension relief strap.

12. A method comprising assembling a kit, the kit comprising:
a garment to be worn by a user;
a fall arrest safety harness integrated into the garment; and
a suspension relief strap configured to be coupled to the fall arrest safety harness, and wherein the fall arrest safety harness is integrated into the garment such that, when the garment is worn by the user, the fall arrest safety harness is worn by the user in a manner that arrests a fall by the user when the fall arrest safety harness is anchored.

13. The method of claim 12, wherein assembling the kit comprises inserting the garment, the fall arrest safety harness integrated into the garment, and the suspension relief strap into a package.

14. The method of claim 12, wherein the safety harness is removable from the garment.

15. The method of claim 12, wherein the safety harness is not overtly visible when viewing the garment.

16. The method of claim 12, wherein the garment comprises overalls.

17. The method of claim 12, wherein the garment includes a portion that, when worn by the user, substantially surrounds an upper thigh area of the user.

18. The method of claim 12, wherein the garment comprises an odor-control garment.

19. The method of claim 12, further comprising a tether configured to anchor the fall arrest safety harness.

20. The method of claim 19, wherein the tether is coupled to the fall arrest safety harness via stitching.
